(19) United States
(12) Patent Application Publication
(10) Pub. No.: US 2008/0306999 A1
(43) Pub. Date: Dec. 11, 2008

(54) SYSTEMS AND PROCESSES FOR PRESENTING INFORMATIONAL CONTENT

(76) Inventors: Brienne M. Finger, Bellevue, WA (US); Steve Okamoto, San Jose, CA (US); Shamim Samadi, Mountain View, CA (US); Rajas Moonka, San Ramon, CA (US); Poorva Arankalle, Redmond, WA (US)

Correspondence Address: FISH & RICHARDSON P.C., PO BOX 1022, MINNEAPOLIS, MN, 55440-1022, US

(21) Appl. No.: 11/760,709

(22) Filed: Jun. 8, 2007

(51) Int. Cl. G06F 17/30

(52) U.S. Cl. 707/104.1; 707/E17.044

(57) ABSTRACT

Systems, processes, and devices may manage the presentation of information in association with the presentation of media. Media to be presented to a user may be identified and concepts related to the identified media may be determined. Items of non-advertising informational content corresponding to one or more of the concepts may be identified. At least one of the items of non-advertising informational content may be presented to a user in association with the presentation of the media.

### TECHNICAL FIELD

The present invention relates to presenting information.

### BACKGROUND

Libraries of online videos and other types of media are available from various media providers, such as YouTube, Google Video, Yahoo Video, radio stations, social networking sites, and/or television networks. Users may access various media providers on the Internet and select media to view. Advertisers often use online video libraries as another way to reach their customers and place advertisements on the media providers' websites. Users may be presented with advertisements on a web page in which the selected media is presented and/or in pop-up windows while viewing selected media.

### SUMMARY

Systems, processes, and devices manage the presentation of information such as non-advertising informational content in association with media. A user may access a media player, which may be on a website of a media provider, and select media to be presented on the media player. In association with the presentation of the selected media, non-advertising informational content may be presented to the user.

In one general aspect, an identification of the media for presentation to a user is received and concepts related to the identified media are identified. One or more items of non-advertising informational content corresponding to one or more of the concepts are identified. The identified media is presented to the user and at least one of the items of non-advertising informational content is also presented to the user in association with presenting the identified media.

Various implementations include one or more of the following features. The concepts may include a corresponding identifier. Identifying one or more of the concepts of a media item may include analyzing the media to automatically extract information that may be used in determining one or more of the concepts. Analyzing the identified media may include at least one of analyzing an RSS feed associated with the identified media, performing a speech-to-text analysis of the identified media, performing an analysis of images in the identified media, performing an analysis of text in the identified media, and/or performing an analysis of sound in the identified media. An identification of one or more of the concepts related to the identified media may be received from a media provider of the identified media. Items of non-advertising informational content may include news, a poll, an image, and/or other media from a media provider of the identified media. Identifying one or more items of non-advertising informational content may include identifying one or more of the items of non-advertising informational content from a specified database. Presenting at least one of the items of non-advertising informational content may include presenting at least one of the items of non-advertising informational content in a window of a web browser user interface and/or at one or more specified points during the presentation of the identified media to the user. At least one of the items of non-advertising informational content may be presented at points, during the presentation of the identified media, specified by a media provider. The window in which the non-advertising informational content is presented may include buttons. The presentation of items in the window may be controlled using the buttons, which allow, for example, playing, skipping, rewinding, fast forwarding, pausing, closing, and/or minimizing the presentation. The window may minimize after a specified period of user inactivity. A selection of at least one of the presented item of non-advertising informational content may be received from the user and a second window associated with the selected non-advertising informational content may be presented to the user. The presentation of the items may cease after a specified period of time has elapsed.

In another general aspect, an identification of media for presentation to a user is received and concepts related to the identified media are determined. One or more items of non-advertising informational content corresponding to one or more of the concepts are identified and a set of informational content to be presented with the identified media is generated. The set of informational content includes at least a portion of the identified items of non-advertising informational content.

Various implementations may include one or more of the following features. Advertisements corresponding to at least one of the concepts may be identified and the set may include at least a portion of the identified advertisements. The set may be a rotational set and each item of the rotational set may be presented for a specified period of time. Parameters for the rotational set may be received from a media provider of the identified media. The parameters for presenting the rotational set may include first indicia for presentation with non-advertising informational content and second indicia for presentation with advertising. An interaction of a user with at least one of the items of the set may be determined when the set is presented to the user and at least one parameter of the set may be modified based on the determined interaction.

In another general aspect, a memory stores non-advertising informational content and/or advertisements. An analysis module receives an identification of media for presentation to a user, determines concepts related to the identified media, identifies items of non-advertising informational content and/or advertisements corresponding to one or more of the concepts, generates a rotational set of items including at least a portion of the identified non-advertising informational content, and/or monitors user interaction of at least one of the presented items of non-advertising informational content. A presentation module presents the media to a user and/or presents at least one of the items of non-advertising informational content to the user in association with presentation of the identified media.

The details of one or more implementations are set forth in the accompanying drawings and the description below. Other features will be apparent from the description and drawings, and from the claims.

### DESCRIPTION OF DRAWINGS

FIG. 1 illustrates an example system for managing the presentation of non-advertising informational content.

FIG. 2 illustrates an example system for controlling the presentation of non-advertising informational content.

FIGS. 3A and 3B illustrate an example process for presenting non-advertising informational content.

FIG. 4 illustrates an example presentation of an item of a rotational set and media.

FIG. 5 illustrates another example presentation of an item of a rotational set and media.

FIG. 6 illustrates a third example presentation of an item of a rotational set and media.

FIG. 7 illustrates a fourth example presentation of an item of a rotational set and media.

Like reference symbols in the various drawings indicate like elements.

### DETAILED DESCRIPTION

In various implementations, the presentation of information, such as non-advertising informational content, in association with a media item is facilitated. Non-advertising informational content refers to, for example, news (e.g., from the Reuters RSS feed, from a tabloid, from Google News, etc.) or other factual information (e.g., from online encyclopedias, online biographies, etc.), polls or surveys, images, still portions of video, or other media available from a media provider. Items of non-advertising informational content can include any combination of text, still graphics or images, moving graphics or images (e.g., video, animation), and audio. For example, an item of non-advertising informational content may be interactive media (e.g., polling). An advertisement (or “advertising” or “ad”) can be any content designed to promote a product or a service, or to otherwise give public notice of some subject matter, such as a public service announcement, political advertising, or a help wanted ad. An advertisement may include any combination of text, still graphics or images, moving graphics or images (e.g., video, animation), and audio. The advertisement may be provided by an advertiser or a sponsor entity, which may compensate a media provider for placement of the advertisement.

Media refers to, for example, sound, still or moving images (e.g., video), still or moving graphics, text, or combinations thereof (e.g., audio-video). A media provider (e.g., YouTube, Google Video, television stations, and/or television and/or radio networks) may request non-advertising informational content from a content provider (e.g., an enterprise capable of providing or managing non-advertising informational content) that is to be presented in association with the presentation of media provided by the media provider. The content provider may generate a set of non-advertising informational content and/or advertising and the media provider and/or content provider may provide the parameters of the set.

A user may access a media player (e.g., Windows Media Player), for example on a website of a media provider or on a user's computer that is coupled to a media provider, and select media to be presented on the media player. Alternatively, a user may access a website of a media provider and select a link for an item of media. The selection of the link may open a media player (e.g., in the website or in a separate browser window) on which the selected item of media is presented. In association with the presentation of the selected media, a set of non-advertising informational content and/or advertising may be presented to the user. The interaction of the user with items in the presented set may be monitored and the set may be modified based on the monitored user interaction.

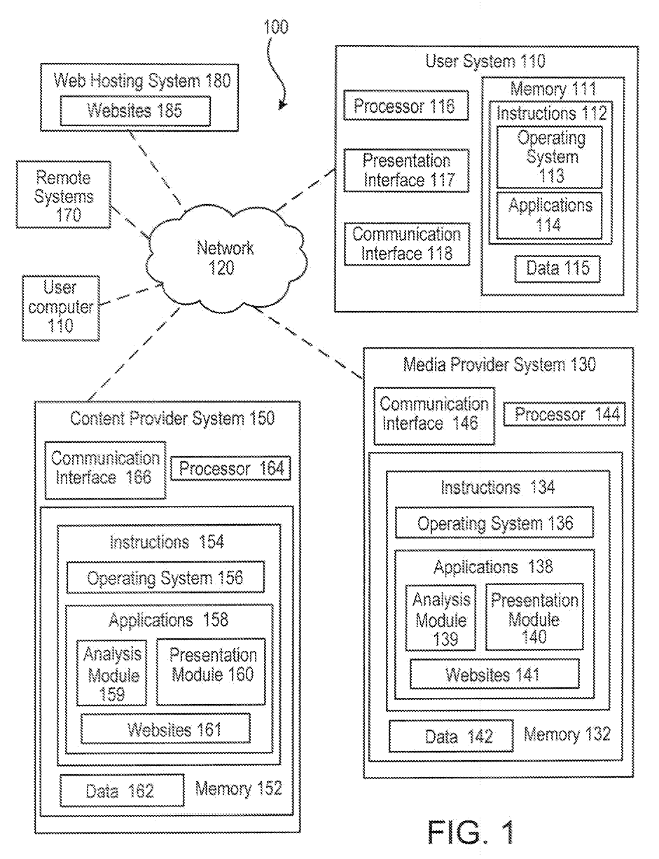

FIG. 1 illustrates an example of a system 100 for the presentation of information. System 100 includes a user computer 110, a media provider system 130, a content provider system 150, remote systems 170, and/or a web hosting system 180 communicably coupled through a network 120.

The user system 110 may be a computer system (e.g., desktop, laptop, smart phone, personal digital assistant (PDA), media player, or other appropriate electronic device) that includes a memory 111 (e.g., hard drive). Instructions 112, such as an operating system 113 and applications 114, and/or other data 115 may be stored on the memory 111. The user system 110 includes a processor 116 to execute the instructions 112, save data 115 and/or retrieve data. The user system also includes a communication interface 118. The communication interface 118 facilitates data transfer between the user computer 110 and other computer systems, such as a media provider systems 130 and/or remote systems 170 through the network 130. For example, a communication interface 180 may facilitate access to websites on web hosting systems 180.

The media provider system 130 may be a server or other computer system that includes a memory 132. Instructions 134 including an operating system 136 and applications 138, such as one or more analysis modules 139, a presentation module 140, and/or websites 141, may be stored on the memory 132. The analysis module 139 may be executable to identify media for presentation to a user. For example, the analysis module 139 may, for example, receive an indication of a media file selected by a user and identify the media based on the indication. The analysis module 139 may also be executable to determine concepts (e.g., subject matter identifiers, descriptors, keywords, or the like) related to identified media. For example, the analysis module 139 may upon receipt of an identification of a selection of media from a user and analyze the media to automatically identify concepts associated with the media. The analysis module 139 may be executable to identify concepts by analyzing the media using analysis tools such as, speech, image, and/or text analysis tools, and determine concepts based on the results of the analysis tools. The analysis module may also be executable to monitor and/or analyze user interaction to the presentation of non-advertising informational content and/or advertisements. For example, the analysis module may receive an indication of user interaction from a user computer (e.g., cookies no the user's computers may record and transmit user interaction) and analyze the user interaction. User interaction may be analyzed by the analysis module, for example, to better target the items, in the set presented to the user, to the user and/or determine whether content is reaching its intended audience. In some implementations, the analysis module may, additionally or alternatively, be executable to identify item(s) of non-advertising informational content corresponding to one or more of the concepts, to identify advertising corresponding to one or more of the concepts, and/or to generate and/or modify a rotational set of items including non-advertising informational content and/or advertisements.

The presentation module 140 may be executable to present media selected by a user. For example, the presentation module 140 may retrieve the media selected by the user and generate and/or transmit the media for presentation to the user on the user's computer. In some implementations, the presentation module 140 may also, or alternatively, be executable to present advertising and/or item(s) of non-advertising informational content to a user (e.g., in association with presenting identified media). The media provider system 130 may also store data 142, such as media (e.g., videos, podcasts, music, streams, audio, etc.), and/or parameters for sets of information to be presented with media on the memory 132.

The media provider system 130 includes a processor 144 to execute the instructions 134, save data 142 and/or retrieve data. The media provider system 130 also includes a communication interface 146. The communication interface 146 facilitates data transfer between media provider system 130 and other computer systems, such as content provider systems 150 and/or web hosting systems 180 through the network 130. For example, a communication interface 146 may facilitate access to information, such as advertising and/or non-advertising informational content on the content provider systems 150.

The content provider system 150 may be a server or other computer system that includes a memory 152. Instructions 154 including an operating system 156, and/or applications 158, such as one or more analysis modules 159, a presentation module 160, and/or websites 161, may be stored on the memory 152. The analysis module 159 may be used in place of or in conjunction with analysis module 139 of the media provider system 130. The analysis module 159 may perform similar functions as analysis module 139 or different functions depending on the functions of the system, components included in and/or arrangement of the system, media to be presented, sources of non-advertising informational content utilized, etc.

The analysis module 159 may be executable to identify item(s) of non-advertising informational content corresponding to one or more of the concepts, to identify advertisements corresponding to one or more of the concepts, and/or to generate and/or modify a rotational set of items including non-advertising informational content and optionally advertisements. The analysis module 159 may also be executable to identify media for presentation to a user. For example, the analysis module 159 may receive an indication of the media to be presented to the user from the media provider system 130 and/or the web hosting system 180 and identify the media for presentation to the user. The analysis module 159 may also be executable to determine concepts related to identified media. For example, when the analysis module receives an identification of the item of media from the media provider system 130, the analysis module may analyze the media to automatically identify concepts associated with the media. The analysis module may utilize analysis tools (e.g., speech-to-text analysis tool) to analyze the media and identify concepts related to the media. The analysis module may also be executable to monitor and/or analyze user interaction to the presentation of non-advertising informational content and/or advertising. For example, user interactions may be transmitted to the content provider system (e.g., from the user system 110, web hosting system 180, and/or media provider system 130) and monitored using the analysis module.

The presentation module 160 may be executable to present advertising and/or item(s) of non-advertising informational content to a user (e.g., in association with presenting identified media). The presentation module 160 may also, or alternatively, be executable to present the media. For example, the content provider may receive the media (or file path to retrieve the media) from the media provider and combine the media and the items (e.g., non-advertising informational content and/or advertisements) to be presented to the user. Then the combined media and items may be presented by the presentation module 160 of the content provider system 150. Data 162, such as non-advertising informational content (e.g., news, surveys, etc.) and/or advertising, may be stored on the memory 152 or elsewhere. Although a client-server architecture is described, other architectures are possible (e.g., peer to peer, standalone, etc.).

The content provider system 150 includes a processor 164 to execute the instructions 154, save data 162 and/or retrieve data. The content provider system 150 also includes a communication interface 166. The communication interface 166 facilitates data transfer between the content provider system 150 and other computer systems, such as the media provider systems 130, remote systems 170, and/or web hosting systems 180 and/or directly to the end viewer system through the network 130. For example, the communication interface 166 may receive an identification of a media item from the communication interface 146 of the media provider. As another example, the communication interface 166 may facilitate the transmittal of sets of non-advertising informational content and/or advertising to media provider systems 130 and/or web hosting systems 180.

As illustrated in FIG. 1, a web hosting system 180 may host websites, such as websites for presenting media. For example, a media provider 130 and/or a content provider 150 may present websites to users using the web hosting system 180.

Remote systems 170 may be other servers or repositories coupled to the system 100. For example, advertising and/or non-advertising informational content may be stored in a repository (e.g., SQL databases) in the remote system 170. Examples include repositories such as those associated with applications such as Google Image, Froogle, Google News, Google Blog, Google Books, Google Finance, Google Documents, Google Maps, Google Labs, Google Groups, Google Patents, Google Scholar, and/or Google Photos.

Using a user computer 110, a user may access a website 185, 141 to view, or otherwise be presented, media (e.g., streaming video). The user computer 110 may access the website through the network 120. The website 141 may be generated by the media provider 130 and may list media items presentable on the website, for example. In some implementations, the media provider system 130 may utilize a third party such as web hosting system 180 to generate the website 185. The user may select the media to be presented using the presentation interface 117 on the user computer 110. The media provider system 130 may identify the selected media and contact the content provider system 150 to request (or otherwise allow the content provider system 150 to provide) non-advertising informational content to be presented with the selected media. The non-advertising informational content, and optionally advertising, may be stored as data 162 on the content provider system 150 or on a repository of a remote system 170.

The content provider system 150 may generate a set of non-advertising informational content and, optionally, advertising, to be presented with the media by the media provider 130. The content provider system 150 may generate the set based on the selected media and transmit the set to the media provider system 130 and/or the web hosting system 180. The set may be presented (e.g., before, during, after, and/or as a banner during presentation of the media) in association with the selected media on the user computer 110. The content provider 150 and/or the media provider 130 may monitor and/or analyze user interactions (e.g., mouse-over, clicking, or otherwise selecting) with items of the set and may modify the set (e.g., next item presented, content of the set, etc.) based on the analysis of the user interactions.

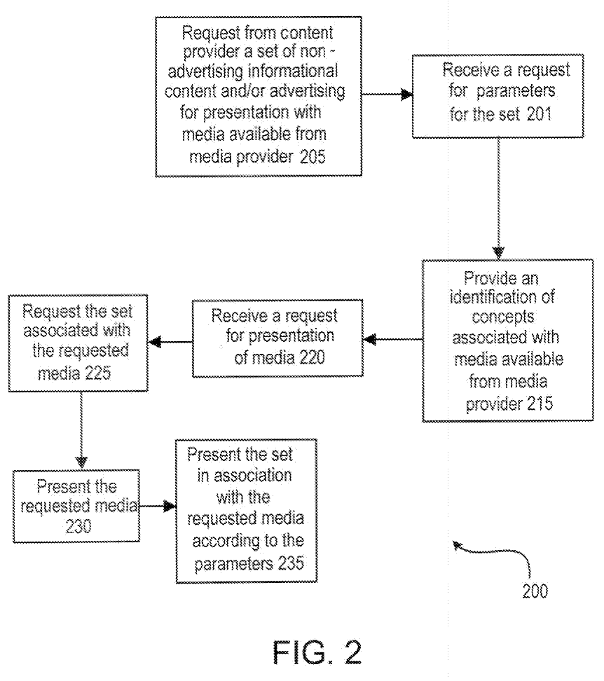

FIG. 2 illustrates an example process 200 for managing the presentation of non-advertising informational content in association with media performed by systems, such as system 100 illustrated in FIG. 1. A set of non-advertising informational content and/or advertising for presentation with media available from a media provider may be requested, such as by a media provider (operation 205). For example, the media provider system may transmit a request (e.g., XML message, e-mail, etc) for a set or a request for a revised set of items. The set may be a collection of items including non-advertising informational content and optionally advertising.

Parameters for the set may be identified (operation 210). In some implementations, a request for parameters is generated/transmitted and processed. Parameters for the set may include, for example, the presentation time for each item in a set, the presentation order of items in a set, the content (e.g., type of item, such as advertising or non-advertising informational content; file paths for items in the set, databases from which items may be retrieved, etc.), the types of control a user is allowed to have (e.g., play, fast forward, rewind, stop, minimize, close, etc.), an amount of time a set may be presented, the number of cycles a set will be presented before obtaining a new set and/or ceasing to present the set, and/or other appropriate parameters. For example, the media provider may specify that a ten item rotational set should be presented in association with the media and three of the ten items should be advertising. The media provider may additionally specify the order of non-advertising informational content and advertising in the set.

The media provider and/or the content provider may specify the parameters. In some implementations, the content provider may specify parameters unless a media provider specifies parameters. In some implementations, a content provider may provide varying levels of control over parameters as part of a service provided (e.g., a media provider may opt to have one of various levels of control).

An identification of concepts associated with media available from a media provider may also be provided (operation 215). The concept identifications may be terms, codes, or images descriptive of the media, in some implementations. For example, a media provider may specify concepts such as basketball and the Houston Rockets, for a video clip of a Rocket's playoff game. The concepts may be provided in a web feed, such as an RSS feed, as metadata, and/or in java script, hidden from a user during presentation but crawlable by a search engine, associated with specified media or collections of media. The concepts may be identified by textual, alphanumeric, images, or other appropriate indicia. For example, the concepts may be identified by textual identifiers that correspond, for example, to objects in a video, conversations in a video or podcast, and/or text in a video.

In some implementations, the concepts may be determined from the media to be presented. For example, the media may be analyzed (e.g., textual, sound, and/or video analysis). From the analysis of the media, one or more concepts may be determined by, for example, identifying terms that appear greater than a specified frequency or applying various statistical analysis to identify terms or images that are significant in the media. The concepts may then be associated with the media (e.g., as metadata, in RSS or other web feeds, in java script or HTML associated with the media, etc.).

In some implementations, a database (e.g., memory 132, 152, and/or memory in remote systems 170) may store associations between concepts (e.g., identifiers) and media available from a media provider. The media provider and/or the content provider may generate the associations stored in the database. Once media to be presented to a user is identified, concepts may be retrieved for the identified media from the records of the database. For example, the content provider may identify the media to be presented and request, from a database of the media provider, the concepts associated with the identified media. The content provider may then utilize the concepts to generate a set of non-advertising informational content and/or advertising.

When a request for presentation of media is received (operation 220), a set associated with the requested media is requested (operation 225). For example, when a media provider system, or web hosting server, receives a request for the presentation of media, the media provider may request the set of non-advertising informational content and/or advertising associated with the requested media from the content provider system.

The requested media may be presented (operation 230) and the set associated with the requested media may be presented according to the parameters (operation 235). For example, the set or portion thereof may be presented pre-roll (e.g., before presenting media), mid-roll (during presentation of media) or post-roll (after presenting media). As another example, the set may be presented in a window (e.g., a banner) proximate the window the media is presented in.

Process 200 may be implemented by system 100 or similar systems. In addition, various operations may be added, deleted, modified, or reordered in process 200. For example, the media provider may not specify parameters for the set. As another example, the media provider may specify sources (e.g., databases, records of a database, etc.) from which non-advertising informational content may be selected when generating the set. In addition, the presentation of the set may be ceased after a specified period of time.

As another example, concepts may not be identified prior to receiving a request for presentation of a media item by a user. In addition, the set of items (non-advertising informational content and/or advertisements) may be requested after the request for presentation of a media item has been received and/or identified. Since the set of items may be dynamic (e.g., items in the set may depend on the media presented, the current contents of any databases from which items are provided, the user, parameters provided by the media provider, user interaction and/or the identity of the media provider), the media provider may request a set of items for presentation in association with the media each time a media is requested. In addition, the set (e.g., items in the set, parameters of the set, etc.) may change before the set has been completely presented (e.g., based on user interaction).

In some implementations, determining concepts may include analyzing the media (e.g., to automatically extract information to be used in determining the concepts). The media may be analyzed when the media provider initially requests a set of non-advertising informational content for media and may be periodically updated, or analyzed when a user requests the presentation of media. For example, the media provider system may analyze the media, determine concepts based on the analysis, and provide the concepts to the content provider for media provided by the media provider. As another example, the content provider may analyze the media, determine concepts based on the analysis, and identify non-advertising informational content based on the concepts. Analyzing the media can include identifying concepts from web feeds, such as RSS feeds, metadata, or hidden (e.g., from a user being presented the media) code. Web feed readers or aggregators may be used to analyze the web feed and determine concepts in the web feed associated with the media. In addition, analyzing the media can include analyzing images, text, sound, and/or combinations thereof in media to determine concepts associated with the media. For example, analyzing the media to determine concepts includes, for example, speech-to-text analysis (e.g., analyzing a wave file, MP3 file, or sound file associated with a video to convert the sounds into text).

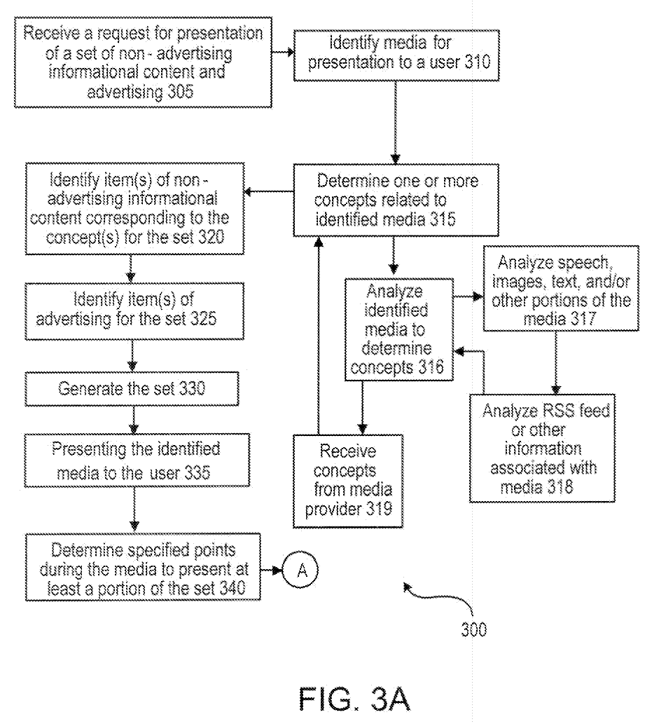

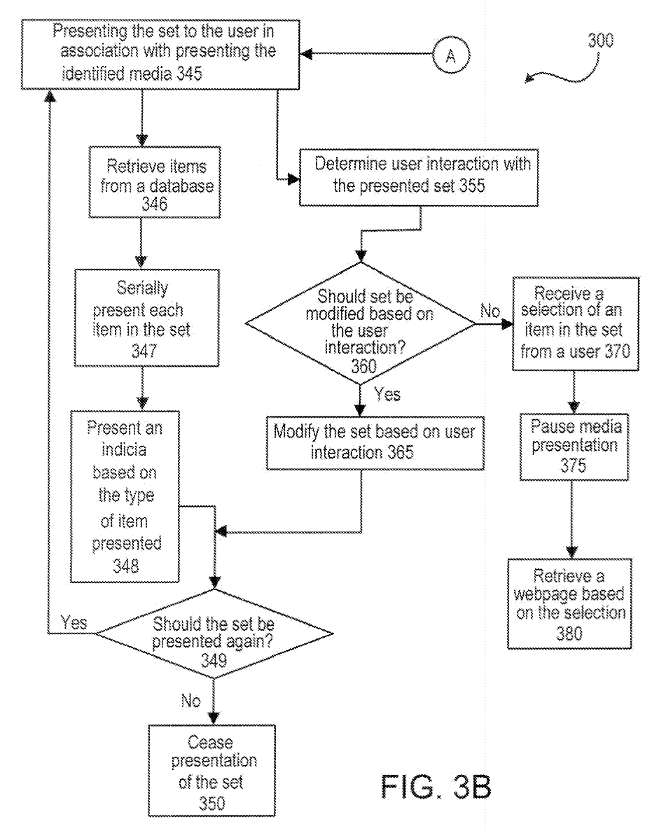

FIGS. 3A and 3B illustrate an example process 300 for presenting information related to media. A request for presentation of a set of items, such as non-advertising informational content and advertising, may be received (operation 305). For example, when a user requests media from a website coupled to a web hosting system or media provider, the web hosting system and/or media provider may request a set of items. The media provider may seek presentation of the set of items to capture and retain a user's interest, such as through the use of a presentation of related news stories, facts, or images and/or through the use of polls. For example, a media provider may include video clips of famous celebrities and, to retain user interest, the media provider may seek to present in association with a selected video clip, news stories about the celebrity in the video, facts or tabloid information about the celebrity or products in the video, and or survey the user about a related topic (e.g., Do you think the celebrity in the video should go to jail for this?). The set of items may also include advertisement related to the video, which may increase profitability of the media provider. However, since the advertisement is presented with a series of other items, such as non-advertising informational content, a user may continue to pay attention to the set of items even when advertisements are presented.

Media for presentation to a user is identified (operation 310). For example, the content provider system may receive an identification of the media to be presented to the user. The media provider system may transmit a message (e.g., XML message) to the content provider that includes an identification of the media. As another example, the media provider may transmit a request (e.g., an XML message) to the content provider for a set to be presented with the media and the content provider may analyze the request and identify the media provider, the parameters for the media provider and/or set, and the media to be presented to the user based on the request. The content provider system may receive the identification of the media. In some implementations, the content provider may analyze the media selected to identify the media. For example, the metadata or other information associated with the media (e.g., title of the media, content of the media, web feed, hidden scripts, etc.) may be analyzed and the media may be identified from the analysis.

One or more concepts related to the identified media are determined (operation 315). Identifying concepts related to the media may include analyzing the media or the information associated with the media (e.g., web feeds, metadata, etc.) and automatically identifying concepts from the analysis. Concepts, such as identifiers, may be descriptive of the media. For example, if text appears in the media, the identifier may include one or more parts of the text. As another example, identifiers may describe or be related to an action or conversation in the media.

The identified media may be analyzed to determine the concepts (operation 316). Speech, images, text, and/or other portions of the media may be analyzed (operation 317). For example, speech-to-text analysis tools, character and/or image recognition tools, and/or scene analysis tools may be utilized. RSS feeds and/or other information associated with the media may be analyzed (operation 318). Concepts may be received from the media provider (operation 319). For example, the media provider may customize a list of concepts associated with media to control the set of items presented in association with the media. A media provider may also transmit or provide access to a database of concepts associated with media provided by the media providers.

In some implementations, concepts may be determined based on the various media analysis techniques based on the frequency of the appearance of words, for example, in the media. For example, the well-known term frequency—inverse document frequency (“TF IDF”) may be calculated for the terms in the text and names and concepts may be select as the terms having the highest TF-IDF. Similarly, items associated with concepts may be identified using similar techniques. For example, the item may be analyzed using, for example, automatic speech and/or image recognition, and then the TF-IDF may be calculated to identify which terms have the highest TF-IDF and thus which terms in the items are similar to the concepts.

Item(s) of non-advertising informational content corresponding to the concept(s) may be identified (operation 320). For example, non-advertising informational content may be identified that is similar or related to the concepts. If a concept was Pepsi, news information such as latest company news, latest product reviews, and/or stock prices may be identified. If a concept was a celebrity name, images of the celebrity, news about the celebrity, and/or polls related to the celebrity may be identified. As another example, identifying non-advertising informational content may include identifying other media available from a media provider or a database specified by the media provider that is related (e.g., based on concepts) to the identified media.

In some implementations, identifying items of non-advertising informational content that is associated with concepts may include characterizing text in the item (e.g., closed-captioned video, subtitled video, titles, documents, etc.) in the items using clusters of conceptually related words. Since concepts may be textual identifiers, variations of the identifiers may be related and thus the variations may be used to improve identification of items associated with concepts. For example, if a concept for a media is “baking”, rather than identifying items associated with baking, the content provider system may identify items associated with words related to baking, such as bakery, bake, bakes, baked, etc. The content provider system may identify variations by selecting candidate clusters of conceptually related words that are related to the concepts of the media to be presented to a user. A model (e.g., a probabilistic model that includes nodes representing random variables for words and clusters of conceptually related words) may be used by the content provider system to select the candidate clusters and a set candidate clusters (e.g., in a vector, such that the relatedness of items in the candidate cluster to the concepts is included in the vector) may be utilized. Although the above describes a process of identifying items related to concepts based on text in the items, similar techniques may be used to determine concepts for media including text.

In addition, text in items may be analyzed to identify items associated with concepts using a model. For example, the model may be a generative model for textual documents that includes terminal nodes representing random variables for words and cluster nodes representing clusters of conceptually related words, which may be identified using a process similar to the above described process. The model may be refined using items or documents designed to improve the model. Similar techniques may be applied to determine concepts for a media to be presented to a user.

In some implementations, items associated with concepts may be identified using speech-to-text analysis tools. For example, sound recognition tools may be applied to items, such as videos or other sound files, to identify words in the items (e.g., speech in the audio track of the video file may be automatically recognized and converted to text). Examples of automatic speech recognition techniques include techniques based on hidden Markov models, on neural networks, and on dynamic programming.

Item(s) of advertising for the set may be identified (operation 325). Advertising may be identified based on parameters provided by the media provider (e.g., the media provider may select sponsored advertisers, the content of the advertisement such as food on a cooking video clip, and/or age appropriateness). The advertisements may be identified based on the concepts associated with the media. The set may be generated (operation 330). Generating the set may include identifying items for inclusion of the set, identifying parameters for presentation of the set, and/or generating a packet of information including the identified items or links (e.g., file paths, URLs, etc.) to the identified items. The set may include a portion of or all of the items of non-advertising informational content and advertisement identified. For example, a content provider and/or media provider may specify a maximum or minimum number of items in a set.

The set may be a rotational set where items are presented serially. The items in the set may be displayed in a specified order (e.g., a parameter of the set provided by the media provider or the content provider) or randomly. Some items may be presented concurrently. For example, more than one (e.g., 3) text advertisements and/or textual non-advertising informational content may be displayed concurrently. Short text ads (e.g., 1-3 sentences) and/or short non-advertising informational content (e.g., 1-3 sentences) may be concurrently displayed to maximize efficient use of the presentation window for the set of items.

The identified media may be presented to the user (operation 335). For example, the identified media may be generated or retrieved by a web hosting system or the media provider and transmitted for presentation on a user computer (e.g., laptop, smart phone). The identified media may be presented in a window (e.g., a Windows® Media Player window).

Specified points during the media may be determined, so that at least a portion of the set may be presented at the specified points (operation 340). In some implementations, the media may be analyzed to determine when the set of items or a portion of the set of items should be presented. Scene analysis tools may be utilized to identify specific points in the media when at least a portion of the set of items should be presented. For example, in online videos of television shows, scene analysis tools may identify breaks in the scene (e.g., where commercials may have originally aired) where at least a portion of the set of items should be presented. The media provider may additionally, or alternatively, provide specific points in the media when at least a portion of the set of items should be presented. For example, at least a portion of a set of items may be presented pre-roll or post-roll.

In some implementations, media to be presented to a user may be parsed to identify points at which the items should be presented to a user. For example, the media may be crawled using known techniques. The media may be analyzed using automatic speech, text, and/or image recognition analysis. The speech recognition may allow recognizing of the time positions in the video in which particular lines or terms in the speech occur. Text from the video or audio file may supplement the speech recognition tools.

Examples of object recognition techniques include appearance-based object recognition, and object recognition based on local features. Automatic object recognition includes recognizing objects in the visual content of a video file and the time positions in the video file in which the recognized objects appear. For example, each frame or a sample of the frames of the video file can be analyzed to recognize and identify objects using appearance-based object recognition or object recognition using local features. The objects can include faces, cars, and objects complied in an objects database.

From the determined time positions in media file points at which items should be presented to the user may be specified. For example, a set of items, such as non-advertising informational content and/or advertisements, may be identified as associated with concepts in the media to be presented using one or more of the described techniques. The parameters of the set may then include the specified points, for example time positions in the video, at which at least a portion of the set should be presented. In some implementations, criteria may be specified in the parameters that identify how the portion of the video to be presented at specified points of the video is selected. For example, the portion may be selected based on concepts identified in the portion of the media preceding, following, or presented during the presentation of the set of items. A number of different criteria may be specified for a single media file, and such different portions of a set or different sets of items may be presented at different specified points of the media presentation.

The set may be presented to the user in association with presenting the identified media (operation 345). Presenting the identified media may include, for example, retrieving the items in the set and transmitting the items according to parameters associated with the set. The set of items may be presented in a window, for example, proximate the window in which the media is presented. In some implementations, the content provider may provide a window with a first portion that is transparent or translucent portion and a second portion for presenting the set of items. The media provider may adjust the size and position of the window to, for example, position the first portion over the media player (e.g., so that presentation of the media is not inhibited by the window for the presentation of the set) and position the second portion (e.g., a banner) at the top or bottom of window in which the media is presented.

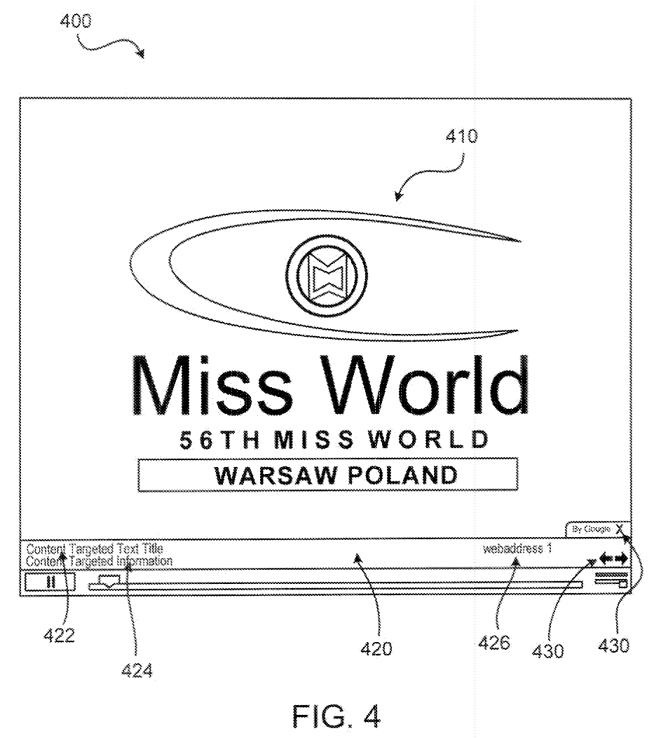

FIGS. 4-7 illustrate examples of presentations of an item of a set and media. As illustrated in FIG. 4, the presentation 400 includes a presentation of media 410 and a window 420 for presenting items of a set of non-advertising informational content and advertisements. The window 420 presents a text advertisement that includes a header 422 and a description 424. In some implementations, advertisement may be retrieved from a database of advertisements (e.g., a memory of a content provider or remote system). When text advertisement is three-lines of text, text add may be concatenated to two lines. For example, the first line may include the header 422 and a web address 426 associated with the advertisement and the second line may be a description 426 forms from a concatenated second and third lines.

The window 420 may include buttons 430 that allow a user to control the presentation of the set of items. The amount of control allowed may be specified (e.g., as a parameter of the set) by the media provider and/or by the content provider. For example, playing and pausing may be allowed, but closing the window may be inhibited (e.g., the button is not presented to the user or is presented differently to signify that the user can not select it). As another example, buttons may be provided that play, rewind, fast forward, skip, pause, and/or stop presentation of items in the set and/or minimize the window 420, maximize the window, and/or close the window. In some implementations, the window 420 may minimize or close after a specified period of time, after a specified number of rotations through the set, and/or after a specified period of user inactivity (e.g., such as periods where the user does not select the item, hover a mouse cursor over the item, etc.).

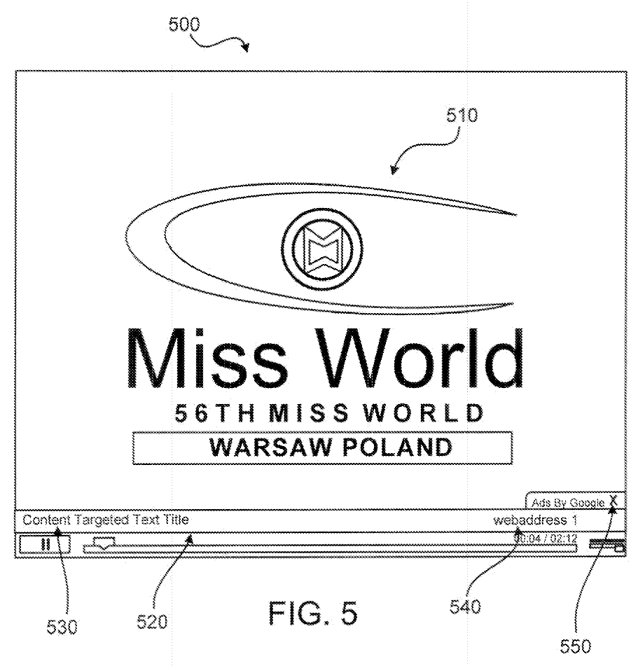

FIG. 5 illustrates an example of a presentation 500 of an item of a set and media. In the presentation 500, the media 510 is presented and the window 520 for presenting items of the set is minimized. When the window 520 is minimized, portions 530, 540 of the item may be presented. The window 520 also includes a button 550 for closing the window.

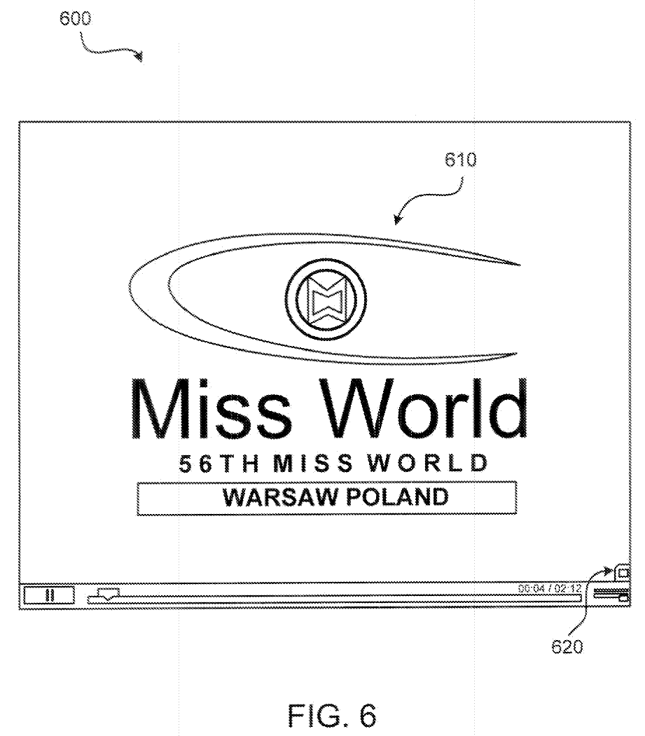

FIG. 6 illustrates an example of a presentation 600 of an item of a set and media. In the presentation, the media 610 is being presented and the window 520 for presentation of items of the set has been closed. As illustrated, button 620 may appear proximate the presentation of the media 610 that maximizes the window.

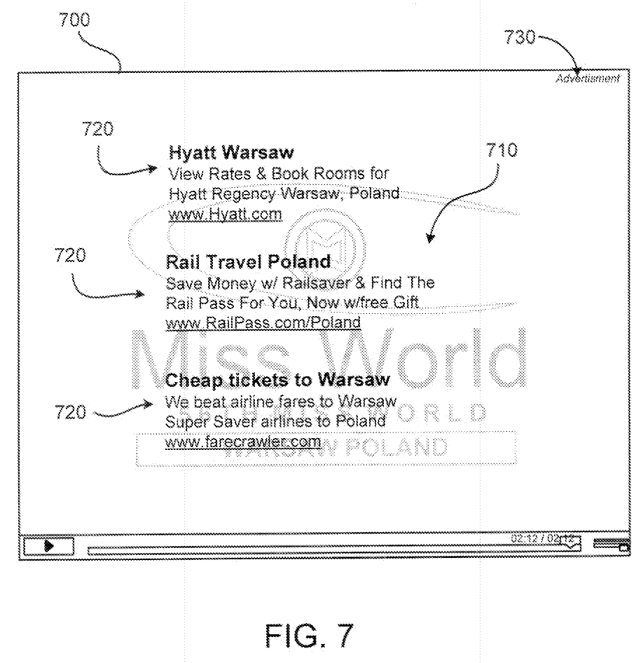

FIG. 7 illustrates another example of a presentation 700 of an item of a set and media. In the presentation 700, the media 710 has been paused and the window for presentation of the items 720 of the set is positioned in over the media (e.g., pre-roll, post-roll, maximize window, etc.). As illustrated in FIG. 7, three text advertisements 720 are presented in the window. The window includes indicia 730 of the type of item (e.g., “advertisement”, “content”) being presented. Although FIGS. 4-7 illustrate advertisements as the items presented in the window, non-advertising informational content or advertisements and non-advertising informational content (e.g., concurrently or serially) may be also be presented in the window.

In some implementations, rather than presenting the set of items in a window separate from the media window, a media stream may be generated including the media to be presented and the set of items to be presented. The web hosting system and/or media provider may generate both the media and set of items in a single media stream. The media stream may be a concatenated version of the media to be presented and/or the set of items to be presented.

Items in the set may be retrieved from a database (operation 346). For example, the database may be a part of the content provider database and as each item is to be presented in association with the media, the item is retrieved from the database. Each item in the set may be serially presented (operation 347). An indicia based on the type (e.g., advertising or non-advertising informational content) of item presented may be presented (operation 348). For example, indicia may include textual indicia, such as including “advertising” or “sponsored content” on the window in which the item is presented. In addition, the indicia may be a color. For example, text in the item or the window itself may be presented in different colors based on the type of item presented. Non-advertising informational content may be presented in a blue or pink window. Using indicia may facilitate retention of a user's attention since the non-advertising informational content may be distinguished from advertising, which may be viewed as less exciting or important to the user.

Once items in a set have been presented to a user, a determination may be made whether the set should be presented again (operation 349). The determination may be made at least partially based on the parameters of the set (e.g., which specify the number of times a set should be presented to the user) and/or user interaction with the set, for example. If the set should not be presented again, then presentation of the set may cease (operation 350). For example, the window in which the set is presented may be closed or minimized. As another example, the window may be blank. If the set should be presented, the set may be presented to the user in association with the presentation of the media (operation 345).

User interaction with the presented set may be determined (operation 355). For example, mouse hovers, cursor hovers, or mouse pauses over the item; selection of items; minimizing or maximizing the window; skipping items; and/or fast forwarding items may be monitored. In addition, an amount of time of presentation prior to an interaction may be monitored (e.g., the amount of time before a user selected the skip button). The monitored user interactions may be used to provide feed back to the media provider, content provider, and/or advertiser. The monitored user interactions may also be used to determine whether to cease presentation of the set and/or modify the set of items. For example, if a specified period of time or level of user inactivity has occurred, presentation of the set may be paused or ceased.

A determination may be made whether the set of items should be modified based on the user interaction (operation 360). The set of items may be modified if user interaction is below a specified level (e.g., no interaction or minimal interaction for a specified period of time) and/or when specified user interactions are detected (e.g., skips, closes, plays, rewinds, etc.). In addition, parameters such as presentation time may be modified when, for example, user interaction is monitored and indicates that a user views each item for 3 seconds before selecting the skip button. Furthermore, data from monitoring user interaction may be aggregated and/or the set may be modified based on the aggregated data. For example, if certain non-advertising informational content items are being skipped by a large number of users, it may not be included in future sets of items. Additionally, presentation times and/or orders may be modified based on aggregated data.

If the set should be modified, then the set may be modified based on user interaction (operation 365). Modifying the set may include modifying the parameters (e.g., presentation time for each item, order, number of items in set, etc.) and/or modifying the set itself. For example, items may be deleted when the level of user interaction is below a specified level. As another example, when items are rewound and replayed or emailed or instant messaged to others, similar items (e.g., same concepts, same advertiser, related videos, etc.) may be added to the set. In addition, if a user skips an item during pre-roll, the order of the set may be altered and same item may be represented during post-roll presentation.

If the set should not be modified or after the set has been modified, a selection of an item in the set may be received from the user (operation 370). For example, the user may click on the web address presented in the item. As another example, the user may answer a poll presented to the user.

The media presentation may be paused or otherwise interrupted, for example, during pre-roll or mid-roll or when a user selects an item in a set (operation 375). A web page may be retrieved based on the selection of the item (operation 380). A second window associated with the selected item may be presented to the user. The second window may be a pop-up window or superimposed on the window in which the media is presented (e.g., the media may be paused while the information in the second window is presented).

Process 300 may be implemented by system 100 or similar systems. In addition, various operations may be added, deleted, modified, or reordered in process 300. For example, a web page may not be retrieved based on the selection and an advertisement (e.g., a full page ad) may be retrieved. In addition, the web page retrieved based on a selection of an item in the set may be presented in a separate window from the media. As another example, the set may rotate continuously through the set until a modification is received, presentation of the media concludes, and/or until the user selects a different media to be presented.

In addition, in some implementations, instant messaging and/or messaging boards associated with a media to be presented may be analyzed to identify concepts associated with the media. For example, the text, sound, images, and/or combinations thereof in the instant messaging and messaging boards may be analyzed to identify the concepts. Items such as non-advertising informational content, and optionally advertising, may then be identified as related to the concepts from the messaging board and/or instant messaging. The identified concepts may then be presented at specified points in the media.

Although a user has been described as a human, a user may be a person, a group of people, a person or persons interacting with one or more computers, and/or a computer system. A user computer may describe one or more computers and/or computer systems.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer (e.g., host or external host) having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

In addition, the systems may include various security technologies that may restrict access to media and data as appropriate. For example, users may need to provide user information (e.g., user name, password, biometric data, and/or combinations thereof) to receive access to the media and/or data. Various other security technologies (e.g., cookies, private key infrastructures, public key infrastructures, etc.) may be implemented in the system to comply with government and/or industry regulations and/or standards (e.g., to protect minors, regulating alcohol and tobacco advertising, etc.).

A number of implementations have been described. Nevertheless, it will be understood that various modifications may be made without departing from the spirit and scope of the invention. Accordingly, other implementations are within the scope of this application.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “an item” includes two or more items and reference to “an item of non-advertising informational content” includes a combination of two or more or different types of items of non-advertising informational content.

What is claimed is:

1. A computerized method for presenting information related to media, the method comprising:
receiving an identification of media for presentation to a user;
identifying one or more concepts related to the identified media;
identifying one or more items of non-advertising informational content corresponding to one or more of the concepts;
presenting the identified media to the user; and
presenting at least one of the items of non-advertising informational content to the user in association with presenting the identified media.

2. The method of claim 1 wherein one or more of the concepts include a corresponding identifier.

3. The method of claim 1 wherein identifying one or more of the concepts includes analyzing the identified media to automatically extract information used in determining one or more of the concepts.

4. The method of claim 1 wherein analyzing the identified media includes at least one of analyzing metadata associated with the identified media, analyzing an RSS feed associated with the identified media, performing a speech-to-text analysis of the identified media, performing an analysis of images in the identified media, performing an analysis of text in the identified media, or performing an analysis of sound in the identified media.

5. The method of claim 1 further comprising receiving an identification of one or more of the concepts related to the identified media from a media provider of the identified media.

6. The method of claim 1 wherein one or more of the items of non-advertising informational content includes at least one of news, a poll, an image, or a second media from a media provider of the identified media.

7. The method of claim 1 wherein identifying one or more items of non-advertising informational content includes identifying one or more of the items of non-advertising informational content from a specified database.

8. The method of claim 1 wherein presenting at least one of the items of non-advertising informational content comprises presenting at least one of the items of non-advertising informational content in a window of a web browser user interface.

9. The method of claim 1 wherein presenting at least one of the items of non-advertising informational content comprises presenting at least one of the items of non-advertising informational content at one or more specified points during a presentation of the identified media to the user.

10. The method of claim 9 further comprising presenting at least one of the items of non-advertising informational content at points, during the presentation of the identified media, specified by a media provider.

11. The method of claim 8 further comprising controlling the presentation of at least one of the items in the window using one or more buttons in the window.

12. The method of claim 11 wherein controlling the presentation using one or more of the buttons includes allowing at least one of playing, skipping, rewinding, fast forwarding, pausing, closing, or minimizing the presentation.

13. The method of claim 8 further comprising minimizing the window after a specified period of user inactivity.

14. The method of claim 1 further comprising receiving a selection of at least one of the presented item of non-advertising informational content from the user and presenting a second window associated with the selected non-advertising informational content.

15. The method of claim 1 further comprising ceasing the presentation of the at least one the item after a specified period of time has elapsed.

16. An article comprising machine-readable medium storing instructions for presenting information related to media presented, the instructions operable to cause data processing apparatus to perform operations comprising:
receiving an identification of media for presentation to a user;
identifying one or more concepts related to the identified media;
identifying one or more items of non-advertising informational content corresponding to one or more of the concepts; and
generating a set of informational content to be presented with the identified media, wherein the set of informational content includes at least a portion of the identified items of non-advertising informational content.

17. The article of claim 16 wherein the instructions are further operable to cause data processing apparatus to perform operations comprising identifying advertisements corresponding to at least one of the concepts, and wherein the set includes at least a portion of the identified advertisements.

18. The article of claim 17 wherein the set comprises a rotational set, wherein each item of the rotational set is presented for a specified period of time.

19. The article of claim 18 wherein the instructions are further operable to cause data processing apparatus to perform operations comprising receiving parameters for the rotational set from a media provider of the identified media.

20. The article of claim 19 wherein parameters for presenting the rotational set include:
first indicia for presentation with non-advertising informational content; and
second indicia for presentation with advertisements.

21. The article of claim 18 wherein the instructions are further operable to cause data processing apparatus to perform operations comprising:
determining an interaction of a user with at least one of the items of the set when the set is presented to the user; and
modifying at least one parameter of the set based on the interaction.

22. A system comprising:
a memory storing non-advertising informational content;
an analysis module adapted to:
receive an identification of media for presentation to a user;
identify concepts related to identified media; and
identify one or more items of the non-advertising informational content corresponding to one or more of the concepts; and
a presentation module, wherein the presentation module is adapted to present the media to a user and present at least one of the items of non-advertising informational content to the user in association with presenting the identified media.

23. The system of claim 22 wherein the analysis module is adapted to identify advertisements corresponding to one or more of the concepts, and wherein the memory further stores the advertisements.

24. The system of claim 22 wherein the analysis module is adapted to generate a rotational set of items including at least a portion of identified non-advertising informational content.

25. The system of claim 22 wherein the analysis module is adapted to monitor user interaction of at least one of the presented items of non-advertising informational content.

26. A system comprising:
means for receiving an identification of media for presentation to a user;
means for identifying one or more concepts related to the identified media;
means for identifying one or more items of non-advertising informational content corresponding to one or more of the concepts; and
means for generating a set of one or more of the items for presentation in association with the identified media.

27. The system of claim 26 further comprising means for presenting at least a portion of the set to the user in association with presenting the identified media.

28. The system of claim 27 further comprising a means for monitoring user interaction with at least a portion of the set presented to the user.
